(19) United States
(12) Patent Application Publication
(10) Pub. No.: US 2001/0014251 A1
(43) Pub. Date: Aug. 16, 2001

(54) Curtain-rail assembly with rail connector

(75) Inventor: Gunter Gastmann, Essen (DE)

Correspondence Address: THE FIRM OF KARL F ROSS, 5676 RIVERDALE AVENUE, PO BOX 900, RIVERDALE (BRONX), NY, 10471-0900, US

(73) Assignee: CEDARGROVE LIMITED

(21) Appl. No.: 09/770,756

(22) Filed: Jan. 25, 2001

(30) Foreign Application Priority Data
Feb. 10, 2000 (DE) 10005830.2

(51) Int. Cl. F16B 1/00; F16D 1/00; B25G 3/00

(52) U.S. Cl. 403/331

(57) ABSTRACT

A curtain-rail assembly in which the rail segments are joined by a connector at meeting ends of the rail segments and the connector has bridging shanks which overlie guide strips of the rail flanking a slot. The bridging flanges are formed with run-up and run-off ramps for a carrier guided through the slots and between the bridging shanks.

### FIELD OF THE INVENTION

My present invention relates to a curtain-rail assembly and, more particularly, to a curtain-rail assembly comprised of hollow rails interconnected at their adjoining ends by a rail connector and receiving hangers which are guided in the interior of the rail segments.

### BACKGROUND OF THE INVENTION

A curtain-rail assembly is described, for example in U.S. Pat. No. 5,993,100 and the corresponding German patent document DE 197 55 828 C2 which has the aligned elongated hollow rails formed on their underside with at least one guide slot flanked by a pair of guide strips and through which the hanger extends to be guided in the interior of the rail segments.

The hanger has a guide flange extending on one side from the hanger body or a pair of such guide flanges extending from opposite sides of the hanger body and formed with surfaces which ride on the guide strips. These guide surfaces may be sliding surfaces or rolling surfaces. The rail segments are connected by a curtain-rail connector extending into the ends of the hollow rails.

Curtain rails of this type have had problems with respect to the interconnection of the rails at their ends because of the lack of a smooth transition across the joint, notwithstanding the presence of a connector which extends into the ends of the rail. The rails are usually extruded hollow profiles and the fabrication tolerances both dimensionally and as to shape and the fact that it is difficult, if not impossible, to exactly align them has resulted in the lack of a smooth transition at the joints. Furthermore, there is a possibility that one of the rails may be tilted with respect to another and the end of the downstream rail can form a barrier at the transition between the rail to the traveling hanger.

While the system of the aforementioned patents can at least in part solve this problem by providing portions of the connector which bridge the two rails, nevertheless the solution has not been fully satisfactory for all configurations of the rails and their segments.

### OBJECTS OF THE INVENTION

It is, therefore, the principal object of the present invention to provide a curtail-rail assembly which can solve the aforedescribed problem and can satisfactorily connect curtain rails or curtain-rail segments of the more modern configurations without difficulty.

More specifically it is an object of the invention to provide an improved curtain-rail assembly with a rail connector which facilitates travel of the hanger through the curtain rail and more reliable passage over the joints between the rail segments even for curved segments or systems in which one rail may be tilted or offset somewhat from the other.

It is also an object of this invention to provide an improved curtain-rail connection system which obviates the drawbacks of earlier systems and is functionally more reliable than such earlier systems.

### SUMMARY OF THE INVENTION

These objects and others which will become apparent hereinafter are attained, in accordance with the invention, in a system in which the connector is provided with a pair of bridging shanks overlying and resting on the guide strips flanking the slots of the rails which are interconnected thereby and wherein these bridging shanks have run-up and run-off ramps extending in the longitudinal direction of the rails and hence in the direction of travel of the hanger. The hanger is designed to ride up and off these ramps in travel over the junction between the ends of the rail segments receiving the connector.

More particularly, the curtain-rail assembly of the invention can comprise:

a pair of aligned elongated hollow rails having adjoining ends and formed on undersides thereof with at least one longitudinally extending guide slot flanked by respective guide strips;

a hanger guided in the rails and extending outwardly through the slot, the hanger comprising a hanger body and at least one guide flange with a riding surface engageable with a respective one of the guide strips and with a set-back ride-up surface; and

a portal-shaped hollow rail connector received in the ends of the rails and interconnecting same, the connector having a pair of opposite longitudinally extending bridging shanks overlying the respective guide strips of the rails and provided with run-up and run-off ramps for the ride-up surface along the connector in a travel direction of the hanger.

As a result, the junction between the rail segments is bridged by a system in which the hanger rides up the run-up ramps and can return to the guide strip via the run-off ramp even when the riding surface of the guide flange may be lifted somewhat from one of the guide strips or from its guide strip. The result is that the danger of blockage of the hanger by offsetting or twisting of the rails relative to one another is completely avoided since the hanger travels without interruption via the ramps and the riding surface of the flange over the junction. The riding surface carries the hanger up the run-up ramp, across the junction and down the run-off ramp until the riding surface returns to the guide strip.

Between the run-up and run-off ramps, bridging surfaces can be formed on the bridging shanks to allow travel across the joint with only a minimum pitch of the run-up and run-off ramps.

As a consequence even with significant dimensional tolerance differences and orientation differences between adjoining rail segments, easy and reliable travel is provided across the junction or the hanger so that a blockage can be completely avoided.

Another advantage of the invention is that precise mounting of the rail segments and hence a high cost of mounting can be avoided. The mounting and assembly is therefore simplified.

The connector can be used without difficulty between curved or arcuate rail segments so that continuous curtains and travel of the hanger is also possible on curved tracks assembled from a number of rail or rail segments.

The bridging shanks can be formed in the region of the joint with centering flanks which define a centering slit for a guide rib or web of the hanger body and this slit can have at least one inlet mouth which guides the rib into the slit and centers the hanger accurately within the rail assembly at the junction.

This eliminates the need for very accurate matching of the guide slots of the rail segments. As a practical matter the centering slit ensures a horizontal fine centering of the hanger on the run-up and run-off ramps as well as on the bridging surfaces therebetween.

The connector can be formed in its middle portion with an outwardly lying spacer collar or segment against which the neighboring rail segments abut so that the rails or rail segments do not contact one another directly at their adjoining ends but abut this spacer collar and thus are positioned with respect to one another with a defined gap.

This facilitates a binding-free mounting of the curtain rails or curtain-rail segments.

To further facilitate the mounting of the connector in the two adjoining rails or rail segments, the invention provides that the connector is formed externally on both sides and at predetermined spacings from the collar with elastic centering cheeks which bear against the inner walls of the hollow rails and clamp the respective parts of the connector in these rails. This automatically orients the guide slit of the connector centrally with respect to the slots of the rail segments.

As a weight-saving measure, the connector can be provided with cutouts in the region of the bridging shanks, the cutouts also serving to ensure a sufficient stability of the connector. The connector of the invention can be composed of a synthetic resin material and can be fabricated without difficulty by injection molding with a generally C section and its bridging shanks lying horizontally. Of course the outer configuration of the connector and its centering cheeks can also be matched to the cross section of the hollow rails.

### BRIEF DESCRIPTION OF THE DRAWING:

The above and other objects, features, and advantages will become more readily apparent from the following description, reference being made to the accompanying drawing in which:

FIG. 1 is a longitudinal section of two adjoining rail segments with a connecting piece according to the invention received therein;

FIG. 2 is a transverse section through the assembly of FIG. 1 showing the connector in an end view but partly broken away;

FIG. 3 is an end view of the connector also partly broken away, but outside of the rail;

FIG. 4 is a view of the connector in the direction of the arrow IV of FIG. 3;

FIG. 5 is a section along the line V-V of FIG. 4;

FIG. 6 is a view of the connector taken in the direction of the arrow VI of FIG, 3, but partly broken away;

FIG. 7 is a side elevational view of a hanger for use with the assembly of FIGS. 1-6;

FIG. 8 is a front view of the hanger of FIG. 7;

FIG. 9 is a section along the line IX-IX of FIG. 7;

FIG. 10 is a plan view of the hanger of FIG. 7;

FIG. 11 is a side elevational view is partly broken away of another hanger for use with the assembly of FIG. 1; and

FIG. 12 is a transverse section through a rail segment showing the hanger of FIG. 7 in place therein either upstream or downstream of the connector.

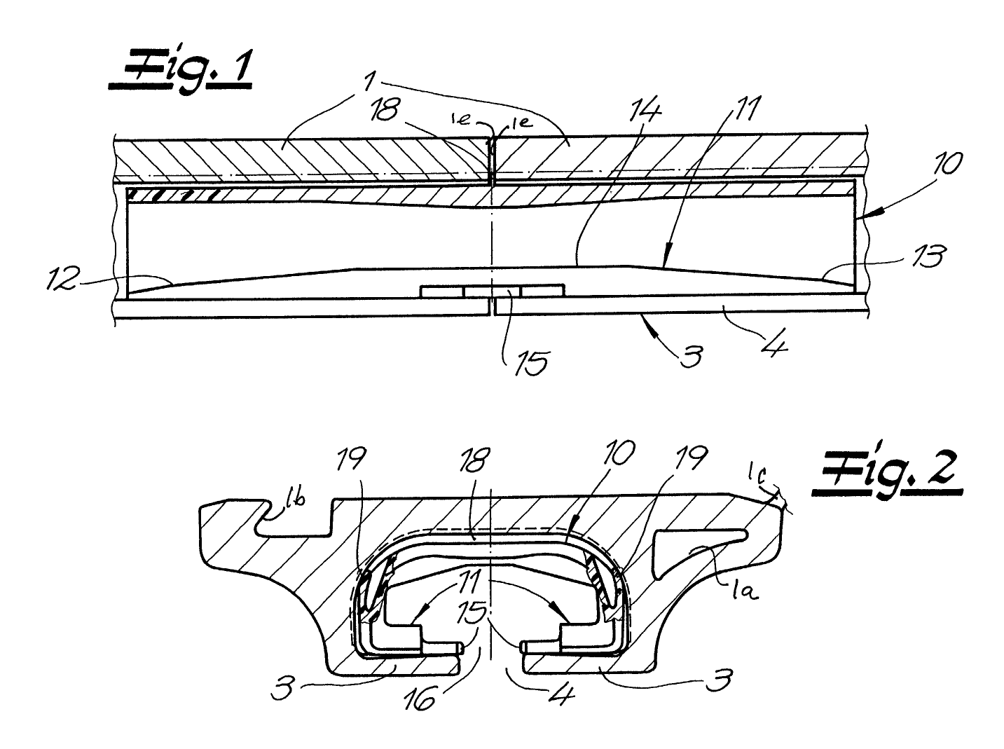

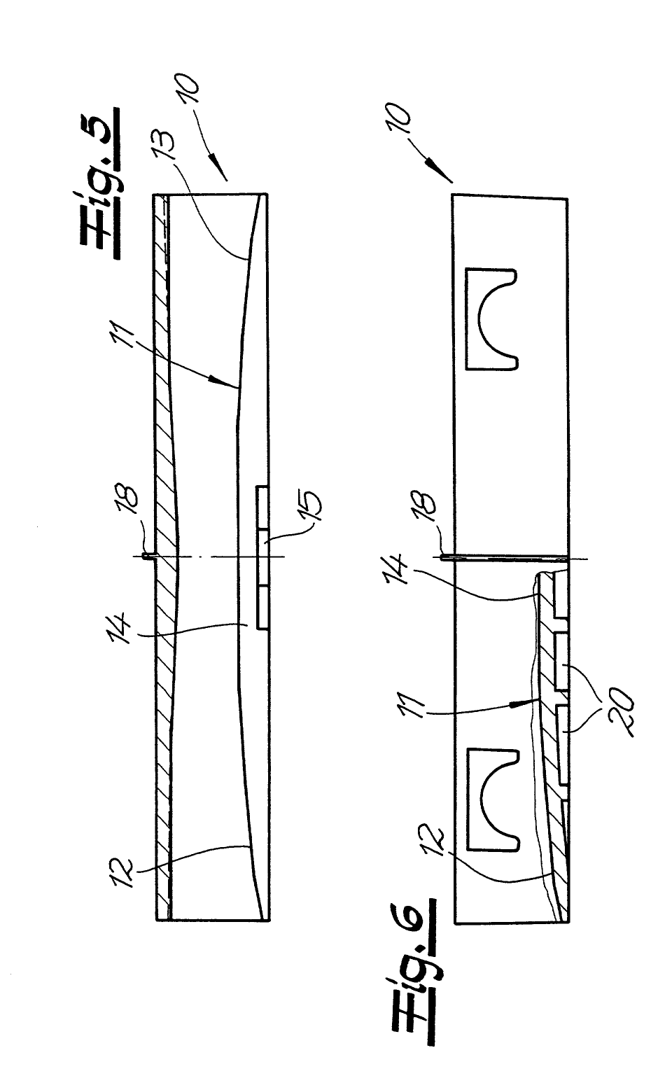

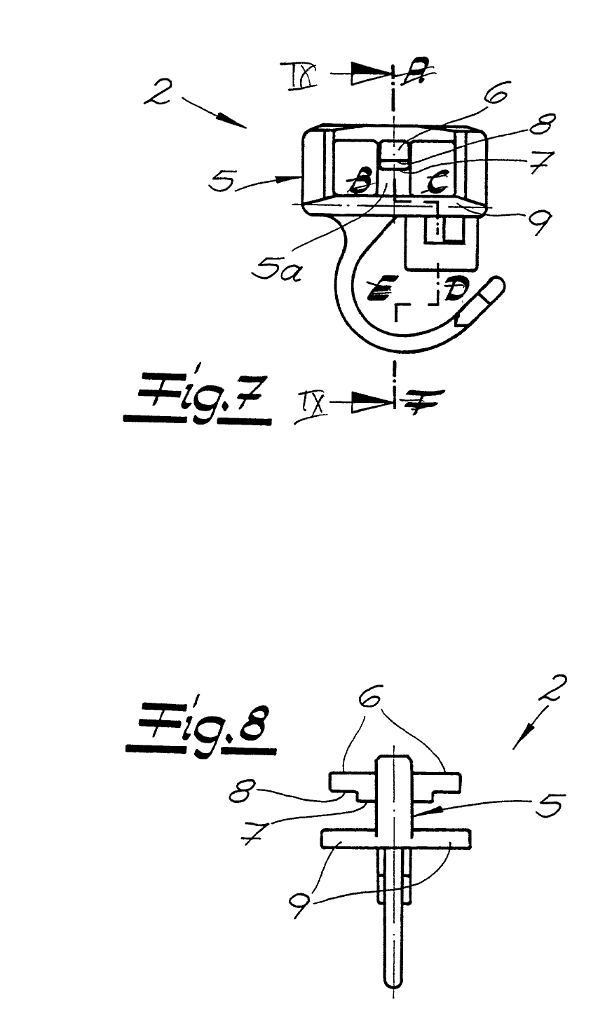

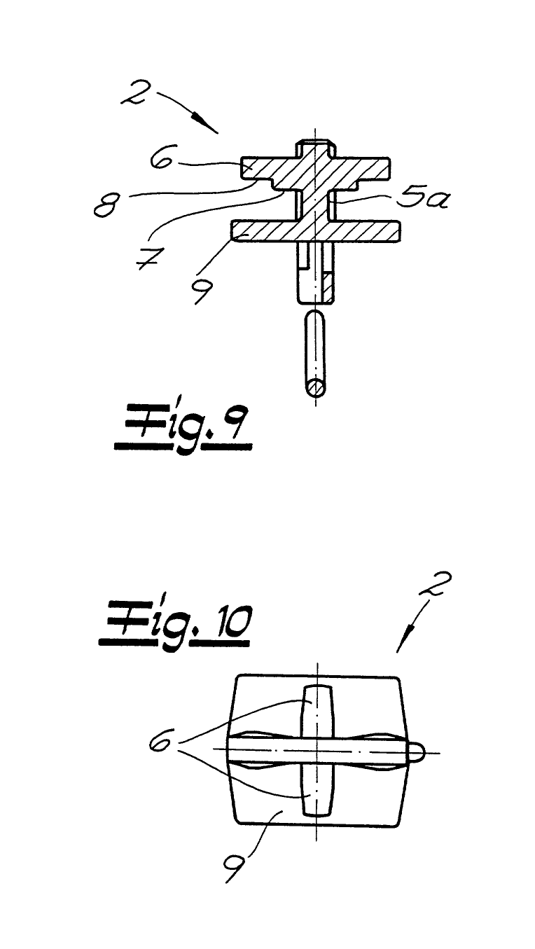

In FIGS. 1-6 I have shown a rail connection-system for the rail segments or rails of a curtain-rail arrangement 1 along which curtain hangers 2 (FIGS. 7-10 and 12) can be guided.

The rails 1 are hollow profiles with at least one slot 4 formed in their undersides and provided with a pair of inwardly-extending guide strips 3 flanking the slot 4. Passages 1a may be provided to reduce the weight of the rail and formations 1b and 1c can be provided for mounting the rail in place.

The hanger 2 is guided in the interior 1d of the rail with its rib or body 5a between the inwardly facing ends 3a of the guide strips 3 (see FIG. 12). The body of the hanger 2 has been represented at 5 and the rib at 5a. A curtain hook 2a is formed on the body 5.

From the central rib 5 in the embodiment of FIG. 7-10, the hanger is formed with guide flanges 6 projecting on opposite sides and each of which has a sliding surface 4 adapted to ride on the respective guide strip 3, and a ride-up surface 8 set back from the ends of the flanges 6. Below the rail 1 and hence below the guide strips 3, each hanger is formed with a pair of oppositely-projecting stabilizing flanges 9.

The rail segments forming the rail are joined by a connecting member 10 whose opposite ends are fitted into the adjoining of the rail segments 1. The connecting member 10 is a portal-shaped member in inverted U configuration.

The connecting member 10 has inwardly-directed bridging shanks 11 with run-up ramps 12 and run-off ramps 13 running in the longitudinal direction for the ride-up surfaces of the hanger 2 or its guide flanges 6. Between the run-up and run-of ramps 12, 13, bridging surfaces 14 are arranged across the joint between the rail segments.

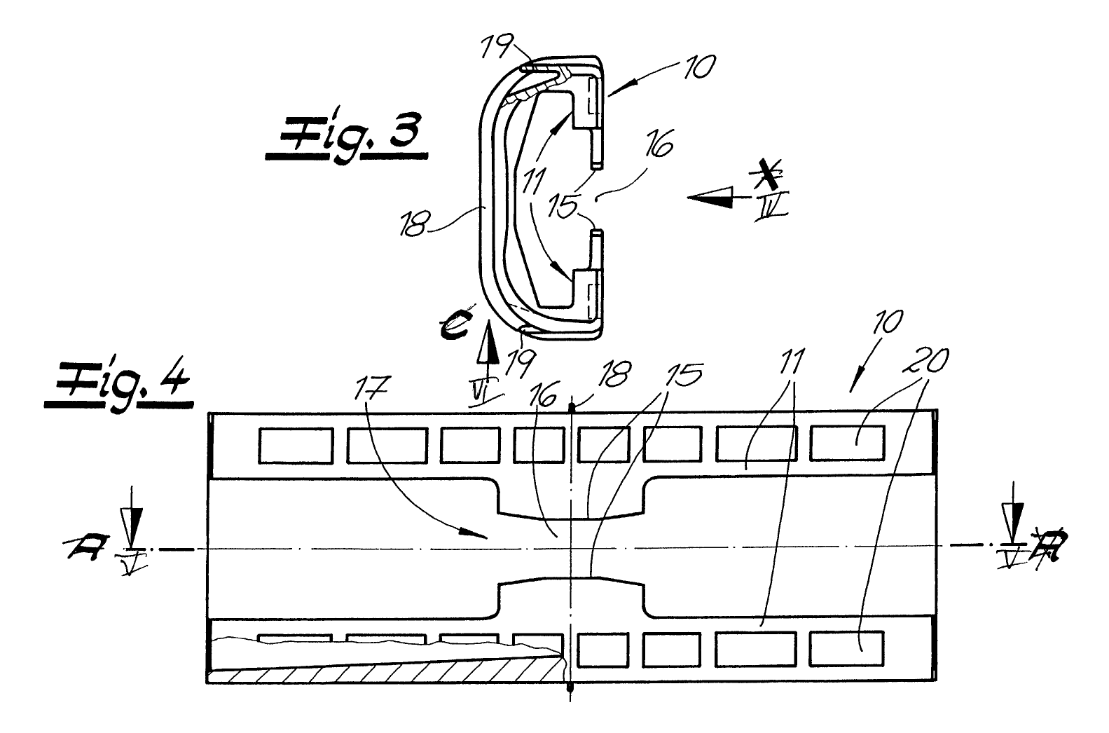

In the region of the joint, the bridging surfaces 14 of the shanks 11 have centering flanks 15 which extend across the joint and define a centering slit 16 between them (FIG. 4). The centering slit 16 is formed with a mouth 17 in which the rib 5a of the hanger is centered as it passes across the junction between the rail segments. The centering flanks 15 are significantly shorter than the bridging shanks 11 and are set downwardly relative to the guide surfaces thereof (see FIG. 3). As a consequence the centering slit 16 fulfills its centering function over a shorter length of the path through the connector and serves to center the hanger within the slot 40 between the guide strips 3.

The connector 10 has, in the region of its center, an external spacing collar 18 against which the ends 1e of the rails 1 abut so that these ends do not abut against one another but rather are spaced apart by the thickness of the collar 18 (FIG. 4).

The connector 10 also has on its exterior, at equal spacings on opposite sides of the collar 18, spring-like elastic centering cheeks 19 for precisely orienting the connector 10 in the respective rails 1. To save material, the connector 10 can be formed, in the region of its bridging shanks 11 with cutouts 20. The portal-like connector 10 with its bridging shanks 11 has a C-shaped cross section (see FIGS. 2 and 3) and can be formed in one piece from a synthetic resin.

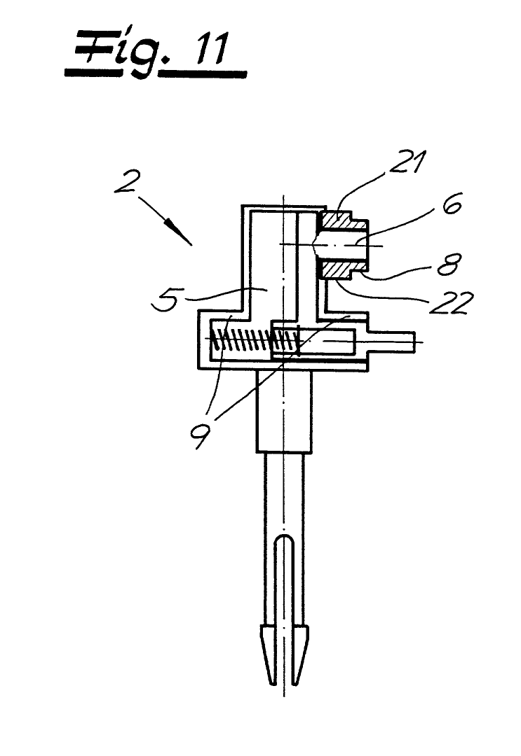

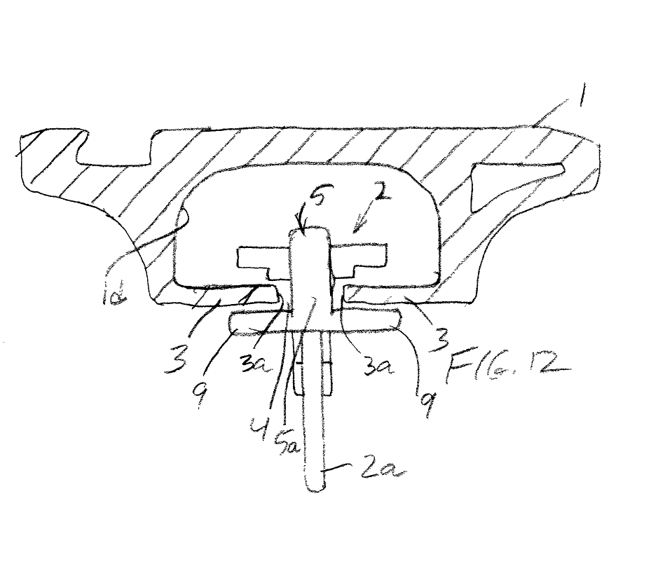

FIG. 11 shows a variant of the hanger 2 in which the flange 6 projects on only one side and is formed with a roller 21 which defines the riding surface. The roller 21 has a ride-up surface 8 as well as the riding surface 22 adapted to run on the respective guide strip 3.

I claim:

1. A curtain-rail assembly comprising:
a pair of aligned elongated hollow rails having adjoining ends and formed on undersides thereof with at least one longitudinally extending guide slot flanked by respective guide strips;
a hanger guided in said rails and extending outwardly through said slot, said hanger comprising a hanger body and at least one guide flange with a riding surface engageable with a respective one of said guide strips and with a set-back ride-up surface; and
a portal-shaped hollow rail connector received in said ends of said rails and interconnecting same, said connector having a pair of opposite longitudinally extending bridging shanks overlying the respective guide strips of said rails and provided with run-up and run-off ramps for said ride-up surface along the connector in a travel direction of said hanger.

2. The assembly defined in claim 1 wherein each of said bridging shanks includes, between the respective run-up and run-off ramps, a bridging surface.

3. The assembly defined in claim 1 wherein said bridging shanks are formed, in a region extending across a joint between said rails, with respective centering flanks ridging said joints and defining a centering slit for centrally guiding said hanger body in said slot.

4. The assembly defined in claim 1 wherein said connector is formed along an exterior thereof and centrally with a spacing collar, said rails abutting said collar and being spaced apart thereby.

5. The assembly defined in claim 1 wherein said connector is formed externally on both sides and at predetermined spacing with elastic centering cheeks.

6. The assembly defined in claim 1 wherein said connector is formed in the region of said shanks with cutouts.

7. The assembly defined in claim 1 wherein said connector with said shanks has a C-shaped cross section with said shanks extending horizontally .

8. The assembly defined in claim 1 wherein said connector is composed of a synthetic resin.

9. The assembly defined in claim 8 wherein each of said bridging shanks includes, between the respective run-up and run-off ramps, a bridging surface.

10. The assembly defined in claim 9 wherein said bridging shanks are formed, in a region extending across a joint between said rails, with respective centering flanks ridging said joints and defining a centering slit for centrally guiding said hanger body in said slot.

11. The assembly defined in claim 10 wherein said connector is formed along an exterior thereof and centrally with a spacing collar, said rails abutting said collar and being spaced apart thereby.

12. The assembly defined in claim 11 wherein said connector is formed externally on both sides and at predetermined spacing with elastic centering cheeks.

13. The assembly defined in claim 12 wherein said connector is formed in the region of said shanks with cutouts.

14. The assembly defined in claim 13 wherein said connector with said shanks has a C-shaped cross section with said shanks extending horizontally.
